(19) United States
(12) Patent Application Publication
(10) Pub. No.: US 2025/0061217 A1
(43) Pub. Date: Feb. 20, 2025

(54) USER INDEXING FOR IDENTIFYING ACCESS TO SENSITIVE DATA

(71) Applicant: Rubrik, Inc., Palo Alto, CA (US)

(72) Inventors: Mudit Malpani, Sunnyvale, CA (US); Muraliraja Muniraju, Fremont, CA (US); Fabiano Botelho, Pleasanton, CA (US); Jeremy Dong, San Francisco, CA (US)

(21) Appl. No.: 18/234,708

(22) Filed: Aug. 16, 2023

(51) Int. Cl. G06F 21/62; H04L 9/40

(52) U.S. Cl. CPC G06F 21/6218; H04L 63/102; G06F 2221/2101; G06F 2221/2141

(57) ABSTRACT

Methods, systems, and devices for data management are described. In some examples, a data management system (DMS) may obtain a snapshot of an identity management system (IMS) that governs access to a set of computing objects for principals. The principals may include users and groups of users. The DMS may obtain metadata for the principals based on information included in the snapshot. Metadata for a principal may include direct group membership information that indicates one or more groups of which the principal is a direct member. The DMS may assign unique values to the principals. The DMS may perform a graph traversal procedure to identify, based on the direct group membership information, a hierarchical structure of the principals. The DMS may generate, based on the graph traversal procedure, membership data structures for the principals. A membership data structure may indicate one or more principals that descend from a corresponding principal.

### FIELD OF TECHNOLOGY

The present disclosure relates generally to data management, including techniques for user indexing for identifying access to sensitive data.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports user indexing for identifying access to sensitive data in accordance with aspects of the present disclosure.

FIG. 2 shows an example of a computing environment that supports user indexing for identifying access to sensitive data in accordance with aspects of the present disclosure.

FIG. 3 shows an example of a unique value configuration that supports user indexing for identifying access to sensitive data in accordance with aspects of the present disclosure.

FIG. 4 shows an example of a hierarchical structure of principals that supports user indexing for identifying access to sensitive data in accordance with aspects of the present disclosure.

FIG. 5 shows an example of a membership data structure configuration that supports user indexing for identifying access to sensitive data in accordance with aspects of the present disclosure.

FIG. 6 shows an example of an access control list (ACL)-to-principal conversion that supports user indexing for identifying access to sensitive data in accordance with aspects of the present disclosure.

FIG. 7 shows an example of a process flow that supports user indexing for identifying access to sensitive data in accordance with aspects of the present disclosure.

FIGS. 8 and 9 show block diagrams of devices that support user indexing for identifying access to sensitive data in accordance with aspects of the present disclosure.

FIG. 10 shows a block diagram of a user index component that supports user indexing for identifying access to sensitive data in accordance with aspects of the present disclosure.

FIG. 11 shows a diagram of a system including a device that supports user indexing for identifying access to sensitive data in accordance with aspects of the present disclosure.

FIGS. 12 and 13 show flowcharts illustrating methods that support user indexing for identifying access to sensitive data in accordance with aspects of the present disclosure.

### DETAILED DESCRIPTION

An identity management system (IMS) may manage access to a set of computing objects for a set of principals. A principal may be an individual user or a group, where a group may be a direct group of users or may be a group of multiple other groups (e.g., subgroups). A data management system (DMS) may facilitate operations by multiple IMSs. In some examples, it may be beneficial for the DMS to identify a set of users that have access to a given computing object and indicate the set of users to a customer. Techniques, systems, and devices described herein relate to determining which users at a customer have access to which aspects of the customer's data based on information obtained from snapshots of the customer's IMS. Such techniques may be used, for example, to determine which users have access to sensitive data (e.g., personally identifiable information (PII), personal medical information, or other sensitive or high risk data) within the customer's system.

Different IMSs may store data and metadata using different (e.g., proprietary) formats, which may not be compatible with each other. Accordingly, to support various analyses, techniques, systems, and devices described herein provide for the DMS to ingest metadata associated with principals from different IMSs and convert that metadata into a unified format, which may be referred to as a user metadata (UMD) format. For example, the DMS may obtain (e.g., from a snapshot of a customer's IMS) metadata regarding the principals associated with a customer's data, and the DMS may perform an index job to convert the metadata from a native format associated with the IMS to the UMD format.

The DMS may also obtain (e.g., from a snapshot of the customer's data and computing objects) a set of access control lists (ACLs) corresponding to the computing objects (e.g., files or directories) within the customer's system. An ACL may be a list of access permissions (e.g., approvals or denials) for a corresponding computing object. The approvals or denials listed within an ACL may each be for a corresponding group or individual user, and whether a corresponding group or user is allowed access to the computing object corresponding to the ACL may depend on the sequential order in which the approvals and denials are listed within the ACL.

As described herein, the DMS may generate, based on the UMD-formatted information, data structures (e.g., bitmaps) that reflect the membership of each principal associated with the customer's data (e.g., which one or more users are included in each group), along with techniques for converting the ACLs into functions (e.g., Boolean expressions) that can be applied to those membership data structures in order to yield (e.g., output) respective sets of one or more users having access to the computing objects associated with the ACLs, which may be referred to as permitted users. Thus, for example, which one or more users are permitted for (e.g., have access to) particular computing objects, including computing objects that contain sensitive data, may be determined and potentially indicated to a user of the DMS (e.g., via a user interface). In some examples described herein, the DMS may classify users according to different risk levels (e.g., based on information obtained from the snapshot of the IMS), such that a user of the DMS may additionally have insight into how risky the permitted users for a given computing object may be.

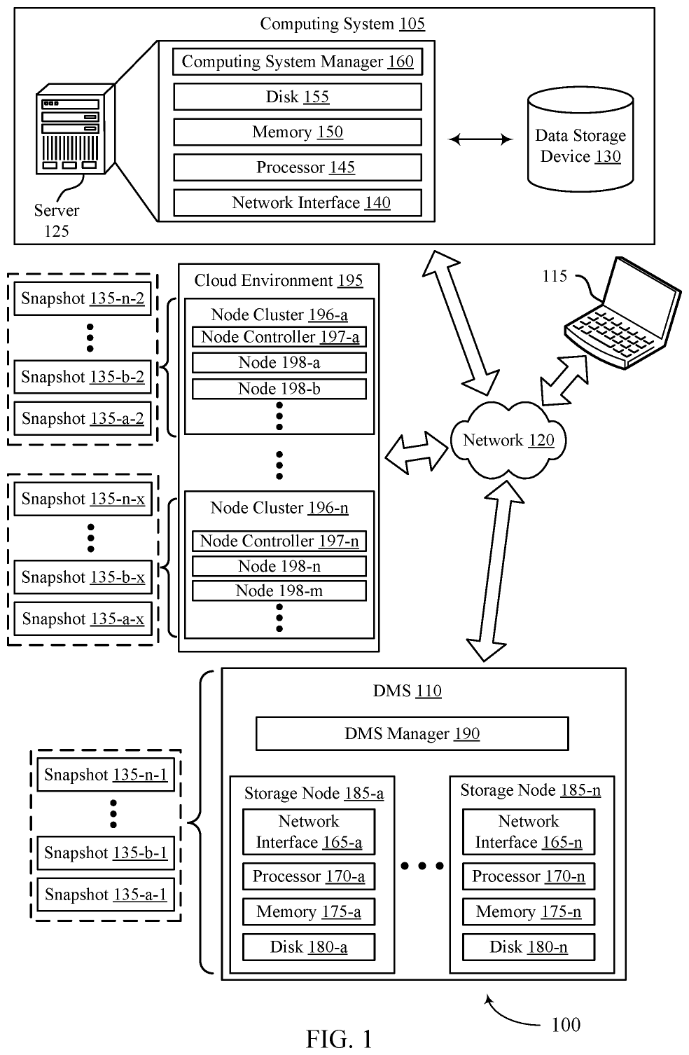

FIG. 1 illustrates an example of a computing environment 100 that supports user indexing for identifying access to sensitive data in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory ((ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190) and any quantity of storage nodes 185. The DMS manager 190 may manage operation of the DMS 110, including the storage nodes 185. Though illustrated as a separate entity within the DMS 110, the DMS manager 190) may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state-which may be referred to as the delta-of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

In some examples, access to client data may be managed by an IMS. The IMS may execute within a network of the client, or within the cloud environment 194, or in some other location. The IMS may manage authorization of principals and access, by the set of principals, to a set of computing objects of the client. A principal may be an individual user or a group, where a group may be a direct group of users or may be a group of multiple other groups (e.g., subgroups). The DMS 110 may provide backup and recovery services for the IMS, as well as one or more other IMSs.

Different IMSs may store data and metadata using different (e.g., proprietary) formats, which may not be compatible with each other. Accordingly, to support various analyses, techniques, systems, and devices described herein provide for the DMS 110 to ingest metadata associated with principals from different IMSs and convert that metadata into a unified format, which may be referred to as a UMD format. For example, the DMS 110 may obtain (e.g., from a snapshot of a customer's IMS) metadata regarding the principals associated with a customer's data, and the DMS 110 may perform an index job to convert the metadata from a native format associated with the IMS to the UMD format.

The DMS 110 may also obtain (e.g., from a snapshot of the customer's data and computing objects) a set of ACLs corresponding to the computing objects (e.g., files or directories) within the customer's system. An ACL may be a list of access permissions (e.g., approvals or denials) for a corresponding computing object. The approvals or denials listed within an ACL may each be for a corresponding group or individual user, and whether a corresponding group or user is allowed access to the computing object corresponding to the ACL may depend on the sequential order in which the approvals and denials are listed within the ACL.

As described herein, the DMS 110 may generate, based on the UMD-formatted information, data structures (e.g., bitmaps) that reflect the membership of each principal associated with the customer's data (e.g., which one or more users are included in each group), along with techniques for converting the ACLs into functions (e.g., Boolean expressions) that can be applied to those membership data structures in order to yield (e.g., output) respective sets of one or more users having access to the computing objects associated with the ACLs, which may be referred to as permitted users. Thus, for example, which one or more users are permitted for (e.g., have access to) particular computing objects, including computing objects that contain sensitive data, may be determined and potentially indicated to a user of the DMS 110 (e.g., via a user interface). In some examples described herein, the DMS 110 may classify users according to different risk levels (e.g., based on information obtained from the snapshot of the IMS), such that a user of the DMS 110 may additionally have insight into how risky the permitted users for a given computing object may be.

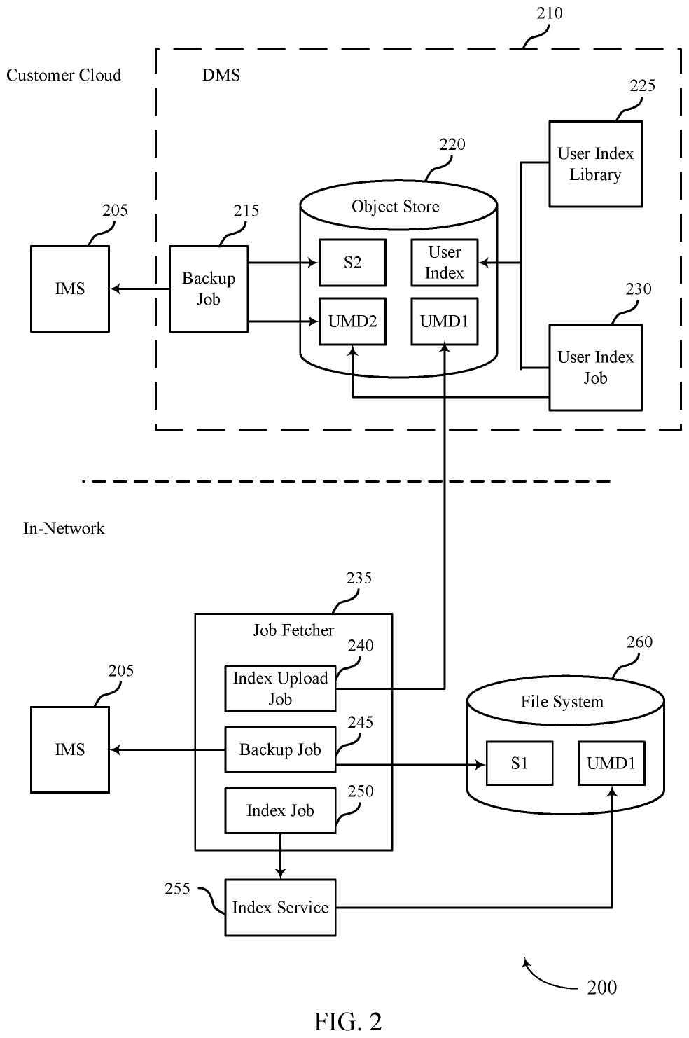

FIG. 2 shows an example of a computing environment 200 that supports user indexing for identifying access to sensitive data in accordance with aspects of the present disclosure. The computing environment 200 may implement or be implemented by aspects of the computing environment 100 described with reference to FIG. 1. For example, the computing environment 200 may include a DMS 210 and one or more components which may execute at the DMS 210 or within a private network of a customer, or both. The DMS 210 may represent an example of the DMS 110 described with reference to FIG. 1.

The computing environment 200 may include an IMS 205, which may execute within a customer network (e.g., within a private network associated with the customer, on-premise at one or more data centers of the customer, or any combination thereof) or within a cloud associated with the customer, or both. The IMS 205 may manage access to a set of computing objects for a set of principals of the customer. A principal may be an individual user or a group, where a group may be a direct group of users or may be a group of multiple other groups (e.g., subgroups). The IMS 205 may manage access and authorization of the principals to the computing objects of the customer. The IMS 205 may, in some examples, represent an example of or be included in an active directory (AD) (e.g., an Azure AD, an OnPrem AD, or the like), or some other type of IMS 205.

The IMS 205 may store data and metadata using a proprietary format, where different IMSs may store data and metadata using different (e.g., proprietary) formats that may not be compatible with each other. Accordingly, to support various analyses associated with different IMSs, the DMS 210 as described herein may index a snapshot of the IMS 205 and convert metadata within the snapshot of the IMS 205 to a unified or standardized format, which may be referred to as a user metadata (UMD) format. The UMD may be generated by mapping from an ID of a principal to a set of common attributes that exist across all systems and a set of one or more secureness attributes, which may differ among systems. An example UMD entry may be a key-value entry, where the key may be an ID (e.g., a security ID (SID)) of a principal, and the value may include a name of the principal, a type of the principal, one or more IDs of direct groups of which the principal is directly a member of (e.g., direct group information), one or more custom secureness attributes, or any combination thereof.

If the IMS 205 executes within a customer's cloud environment, the DMS 210 may obtain the snapshot of the IMS 205. For example, the backup job 215 may take a backup of the IMS 205, where the backup may be or may include a snapshot of the IMS 205. The backup job 215 may store the snapshot (e.g., S2) in an object store 220 of the DMS 210. The backup job 215 may additionally, or alternatively, index the snapshot to generate UMD. The backup job 215 (e.g., or some other component of the DMS 210) may store the UMD for the snapshot in the object store 220 (e.g., UMD2). Indexing the snapshot may include converting a format of metadata in the snapshot to a unified format, such as UMD.

If the IMS 205 executes within a client network, a cloud data management (CDM) system may facilitate the backup and indexing processes before storing the snapshot and the UMD (e.g., S1 and UMD1) at the object store 220. The CDM may include a job fetcher 235, or some other component, which may perform a backup job 245 to obtain a snapshot (S1) of the in-network IMS 205. The backup job 245 may, in some examples, store the snapshot in a file system 260 of the CDM. The snapshot may be stored locally in the file system 260 permanently or temporarily. The job fetcher 235 may perform an index job 250 to index the snapshot and generate UMD for the snapshot. The index job 250 may, in some examples, pass the UMD to the index service 255, which may store the UMD (e.g., UMD1) in the file system 260 temporarily or permanently. The job fetcher 235 may perform an index upload job 240 to upload the UMD1 of the in-network IMS 205 to the object store 220 of the DMS 210.

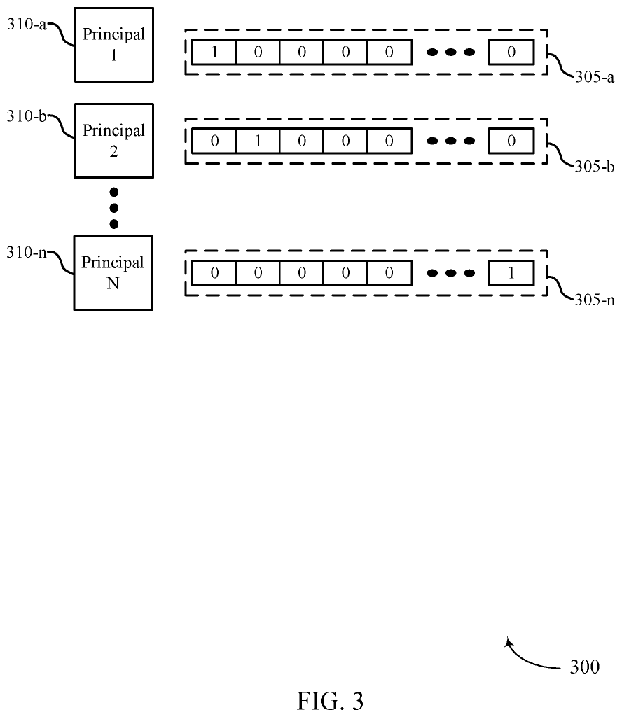

The DMS 210 may execute a user index job 230 based on a user index associated with the UMD to generate unique values that identify each principal in the snapshot and to generate membership data structures for each principal. The unique values and membership data structures may provide for the DMS 210 to identify one or more users that are permitted to access various computing resources of a customer. The unique values and membership data structures are described in further detail elsewhere herein, including with reference to FIGS. 3-5. The user index job 230 may thereby process the UMD and output a user index to the object store 220. The user index may include the unique values and/or the membership data structures.

Once the user index is stored, one or more customers of the DMS 210 or other services may call the user index library 225 to obtain or request information about users and groups within their system. The user index library 225 may receive the requests for information and output the requested information. For example, if a client requests information that indicates which users have access to a given file, the user index library 225 may identify, from a snapshot of the client's data including the file, an ACL for the file. The user index library 225 may convert the ACL to a set of users that have access to the file, and the user index library 225 may output the set of users to the client, as described in further detail elsewhere herein, including with reference to FIGS. 3-6.

The DMS 210 may support backup and recovery of one or more IMSs. By indexing snapshots of the IMSs to generate UMDs and utilizing the UMDs to identify information about various users, the DMS 210 may support improved reliability and efficiency for facilitating customer requests.

FIG. 3 shows an example of a unique value configuration 300 that supports user indexing for identifying access to sensitive data in accordance with aspects of the present disclosure. The unique value configuration 300 may implement or be implemented by aspects of the computing environments 100 and 200, as described with reference to FIGS. 1 and 2. For example, the unique value configuration 300 illustrates a set of unique values 305 that may be assigned to principals 310 of an IMS. In this example, the DMS may assign the unique values 305 based on metadata for the principals 310.

As described in further detail elsewhere herein, including with reference to FIG. 2, the DMS may obtain metadata for principals of an IMS. The metadata (e.g., UMD) may include, among other parameters, an ID for each principal 310 (e.g., an SID). To support various analyses and processes for identifying descendent information within the IMS, the DMS may create a rank system for principals 310. The rank system may provide for the DMS to identify principals 310 using unique values 305 instead of user IDs, which may provide for the DMS to ultimately identify and store descendant information in a space efficient manner that is relatively easy to query. The rank system may include the DMS assigning a respective unique value 305 (e.g., rank) to each principal of the IMS.

The DMS may process a UMD for a given snapshot of an IMS. When processing the UMD, the DMS may assign a unique value 305 (e.g., a global rank) to each newly found principal. The unique value 305 may be used to identify the principal 310 until the principal 310 is removed from the system. The unique value 305 may be an integer that corresponds to a unique position in a bitmap. The bitmap may include a quantity of bits that is the equal to a quantity of principals 310 in the corresponding snapshot of the IMS. That is, each principal 310 may be represented as a unique bit in a bitmap, which may provide for the DMS to find information about principals 310 based on positions in the bitmap.

In the example of FIG. 3, a given snapshot of the IMS may include a quantity, N, of principals 310 (e.g., principals 310-a through 310-n). As such, a bitmap for the unique values 305 may include N bits. The DMS may assign the principal 310-a with a first unique value 305-a, which may correspond to a first position in the bitmap. The unique value 305-a may correspond to a bitmap with a first bit set to a first value (e.g., set high, or set to one) and remaining bits set to a second value (e.g., set low; or set to zero). The DMS may assign the principal 310-b with a second unique value 305-b, which may correspond to a second position in the bitmap. The unique value 305-b may correspond to a bitmap with a first bit set to the second value (e.g., set low; or set to zero), a second bit set to the first value (e.g., set high, or set to one) and remaining bits set to the second value. The DMS may assign each other principal 310 to a respective unique value 305 and corresponding position in the bitmap. The DMS may complete the ranking process when the DMS assigns a final principal 310-n to a unique value 305-n that corresponds to a final position in the bitmap. For example, the unique value 305-n may correspond to a bitmap with all bits set to the second value second value (e.g., set low, or set to zero) except a final bit position, which may be set to the first value (e.g., set high, or set to one).

The DMS may assign the unique values 305 semi-randomly, such that the unique values may simply uniquely identify the principals, but the unique values 305 may not indicate any parameters or other information associated with the principals 310. For example, as the DMS processes UMD for a given snapshot, the DMS may identify the principals 310 included in the snapshot at different times. The DMS may assign the unique values 305 in order of when the DMS identifies the principals 310. In the example of FIG. 3, the DMS may identify the principal 310-a before any other principal in the snapshot, and the DMS may assign the principal 310-a to the first bit position accordingly. The DMS may identify the principal 310-n after all other principals, and the DMS may assign the principal 310-n to the final bit position accordingly. The DMS may thereby continue to process principals 310 and assign unique values 305 until all positions in the bitmap have been assigned an all principals 310 are uniquely identified.

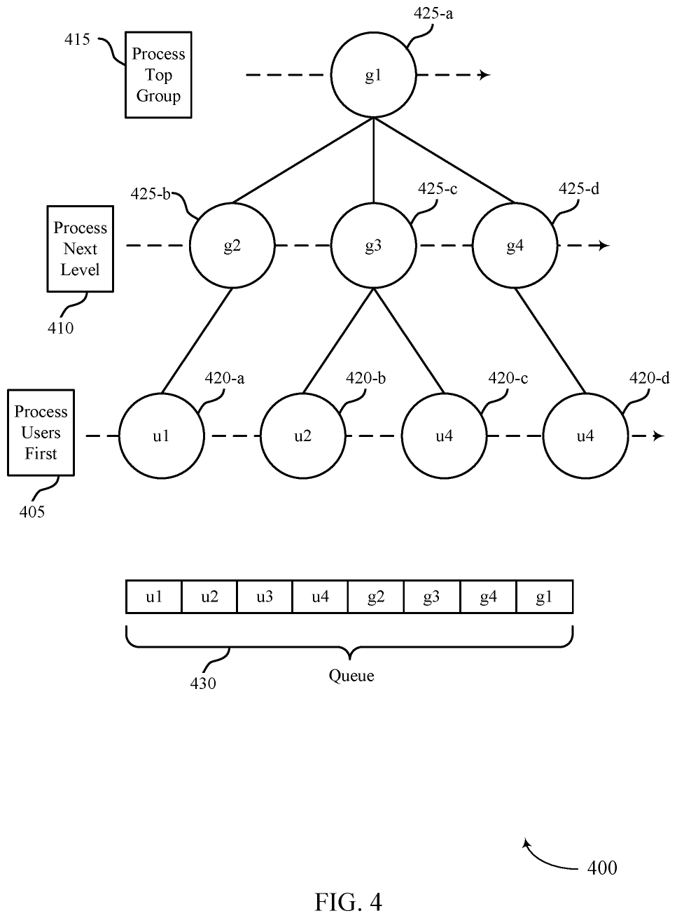

The DMS may store information that indicates each unique value 305. For example, the DMS may store the bitmaps or other information that indicates which principal 310 is assigned to which bit position (e.g., a rank to principal mapping). Each bitmap may be relatively small (e.g., 1,000,000 principals 310 may correspond to 1,000,000 bits in a bitmap, which may be condensed to 125 kilobytes), which may provide for relatively efficient storage. The bitmaps may be easily queryable, as the DMS may efficiently combine bitmaps using bitwise OR operations, as described in further detail elsewhere herein, including with reference to FIG. 4.

FIG. 4 shows an example of a hierarchical structure of principals 400 that supports user indexing for identifying access to sensitive data in accordance with aspects of the present disclosure. The hierarchical structure of principals 400 within the IMS may implement or be implemented by aspects of the computing environments 100 and 200 or the unique value configuration 300, as described with reference to FIGS. 1-3. For example, the hierarchical structure of principals 400 illustrates dependency chains between principals, including users 420 and groups 425 in an IMS, which may represent examples of principals and an IMS as described with reference to FIGS. 1-3. In this example, a DMS may perform a graph traversal procedure to identify the hierarchical structure of principals 400.

As described in further detail elsewhere herein, including with reference to FIG. 2, the DMS may obtain metadata for principals of an IMS. The metadata (e.g., UMD) may include, among other parameters, direct group membership information (e.g., SIDs of direct groups for each principal 410). However, the DMS may not know full descendant information for the IMS based on the metadata alone. For example, the metadata for the user 420-b may indicate an ID of the group 425-c, because the user 420-b may be a direct member of the group 425-c. However, the metadata may not indicate other members of the group 425-c. To obtain complete membership information, the DMS may utilize the direct group membership information to perform a graph traversal and identify the hierarchical structure of principals 400 within the IMS. The hierarchical structure of principals 400 may indicate dependency chains between principals in the IMS.

The graph traversal may be performed in accordance with a search algorithm, which may first process users 420 in the IMS, followed by groups 425 in levels, from the bottom up. That is, the DMS may generate (e.g., build) descendant bitmaps for groups 425 at lower levels in the hierarchy first, and then may combine the bitmaps together at a next level to get a full set of descendants for higher up groups. Each level of the graph traversal may be referred to as an iteration of the graph traversal, in some examples.

At 405, the DMS may perform a first iteration of the graph traversal. The DMS may process users 420 first as part of the first iteration (e.g., a first user level). The DMS may identify, from the snapshot of the IMS, user metadata for each user 420 in the snapshot (e.g., the users 420-a, 420-b, 420-c, and 420-d, among one or more other users). The user metadata may include direct membership information that may indicate one or more principals that each user 420 is a direct member of. For example, the direct membership information for the user 420-a may indicate the group 425-b, the direct membership information for each of the users 420-b and 420-c may indicate the group 425-c, and the direct membership information for the user 420-d may indicate the group 425-d.

The DMS may generate a queue 430 (e.g., a list or sequence) of principals as part of the graph traversal. The DMS may include each of the users 420 in sequential order at a beginning of the queue 430. For each user 420, the DMS may identify the one or more direct groups 425 and may append the identified direct groups to an end of the queue 430. In the example of FIG. 4, the DMS may include the users 420-a through 420-d first in the queue 430, followed by the groups 425-b, 425-c, and 425-d, in order of how the groups 425 are identified via the direct group membership information.

For each user 420, the DMS may take a union of a bitmap that represents the user 420 (e.g., a unique value) and a descendant bitmap of the parent group 425 to obtain a combined set of descendants for the parent. The bitmaps for each principal may start as the unique value for the respective principal. For example, the bitmaps may include all zeros and a single bit set to one at a bit position that identifies the principal, as described in further detail elsewhere herein, including with reference to FIG. 3. After performing the union(s), the bitmaps may be combined to include one or more bits set to one, where the bit(s) that are set to one may be at bit positions that correspond to principals that are descendants of the corresponding principal.

In the example of FIG. 4, as part of the first iteration of the graph traversal, the DMS may identify the group 425-b in the direct membership information for the user 420-a. The DMS may thereby combine a unique value that represents the user 420-a and a unique value that represents the group 425-b. The combination may correspond to a bitwise OR operation, in some examples. The combination (e.g., union) may produce a combined descendant bitmap for the group 425-b. The descendant bitmap, in this example, may include two bits set to a first value (e.g., one) and remaining bits set to a second value (e.g., zero), where the two bits that are set to the first value may be in positions that uniquely identify the user 420-a and the group 425-b, such that the descendant bitmap for the group 425-b may indicate all of the principals that are included in or descend from the group 425-b in the hierarchy.

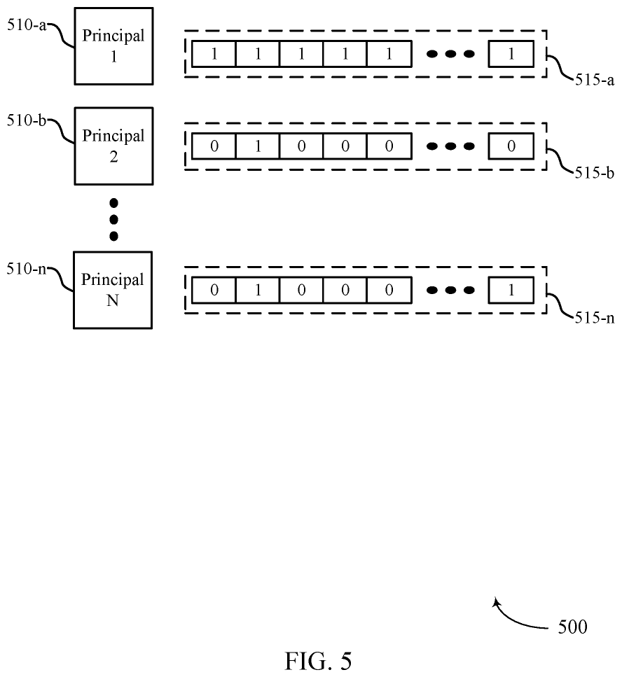

The DMS may perform similar unions for each user 420. The DMS may combine a bitmap for the user 420-b with a bitmap for the group 425-c to obtain a descendant bitmap for the group 425-c. Because the user 420-c is also a direct member of the group 425-c, the DMS may also perform a union between the descendant bitmap for the group 425-c and the bitmap for the user 420-c (e.g., after performing the union between the bitmap for the user 420-b and the group 425-c or at the same time). The resulting descendant bitmap for the group 425-c may include three bits set to the first value and remaining bits set to the second value, where the three bits that are set to the first value may be in positions in the bitmap that uniquely identify the user 420-b, the user 420-c, and the group 425-c. Example descendant bitmaps may be illustrated and described in further detail elsewhere herein, including with reference to FIG. 5.

At 410, the DMS may perform a second iteration of the graph traversal. The DMS may process a first level of groups 425 as part of the second iteration (e.g., a first group level). The DMS may identify, from the snapshot of the IMS, metadata for each group 425 in the first group level of the snapshot. The groups 425 that are included in the first group level may correspond to the groups 425 that are identified by the direct group membership information in the user metadata for the users 420 in the first iteration of the graph traversal. The metadata for each group 425 may include direct group membership information that indicates one or more other groups 425 at a higher level of the hierarchy that the groups 425 are direct members of. In the example of FIG. 4, the direct group membership information for each of the groups 425-b, 425-c, and 425-d may indicate an ID of the group 425-a. That is, the group 425-a may include each of the groups 425-b, 425-c, and 425-d. The DMS may append the group 425-a to an end of the queue 430 based on the group 425-a being identified in the direct group membership information in the second iteration of the graph traversal.

For each group 425 in the first group level, the DMS may take a union of a descendant bitmap for the group 425 and a descendant bitmap of the parent group 425-a to obtain a combined set of descendants for the parent. The descendant bitmaps for the groups 425 of the first group level may be determined during the first iteration of the graph traversal. A descendant bitmap for the parent group 425-a may be incomplete at this stage. Accordingly, the descendant bitmap for the parent group 425-a before the combination may include at least one bit set to a first value in a bit position that uniquely identifies the parent group 425-a.

In the example of FIG. 4, the DMS may perform a first union to combine the descendant bitmap for the group 425-b with the descendant bitmap for the group 425-a. The DMS may subsequently perform a second union between the descendant bitmap for the group 425-c and the updated descendant bitmap for the group 425-a. The DMS may perform a third union between the descendant bitmap for the group 425-d and the updated descendant bitmap for the group 425-a. In some examples, if two or more groups 425 are direct members of a same group 425, such as the group 425-a in FIG. 4, the DMS may perform a single union of the bitmaps for each of the two or more groups and the parent group, or the DMS may perform separate sequential unions. After performing each of the unions (e.g., bitwise OR operations), the DMS may obtain a descendant bitmap for the group 425-a, which may include multiple bits set to a first value. The multiple bits set to the first value may be in bit positions that uniquely identify each principal that is a member (e.g., direct or indirect) of the group 425-a. For example, bits may be set high in positions that uniquely identify each of the users 420-a through 420-d, and each of the groups 425-a through 425-d. The DMS may continue to process one or more additional group levels of the hierarchy in this manner.

At 415, the DMS may process the top group level of the hierarchy. The DMS may identify metadata for the group 425-a based on the snapshot of the IMS. The metadata may not include direct membership information, or the direct membership information may be null for the group 425-a, which may indicate that the group 425-a is not a member of any other groups. The DMS may determine that the graph traversal is complete based on the direct membership information for the group 425-a being null. That is, the DMS may perform multiple iterations of the graph traversal until metadata for all principals included in the snapshot is identified and complete descendant bitmaps for all of the principals are generated.

In some examples, the DMS may perform the union procedures to generate the descendant bitmaps as part of each iteration of the graph traversal, as described. Additionally, or alternatively, the DMS may update the queue 430 during each iteration of the graph traversal, and the DMS may perform the union procedures based on the queue 430 after completing all iterations of the graph traversal. For example, once the DMS completes the queue 430) and identifies a single group 425 that does not include direct membership information, the DMS may sequentially iterate through the queue 430 and perform unions between bitmaps for principals at each level and their corresponding parents.

Although three levels of the hierarchy are illustrated in FIG. 4, it is to be understood that the DMS may traverse any quantity of levels of a principal hierarchy, including a single level, two levels, four levels, or any other quantity. Each level may be identified via direct group membership information for a previous level, starting with users 420 in the snapshot, until no more direct group membership information can be identified. The DMS may thereby generate descendant bitmaps for each principal in the snapshot of the IMS, where the descendant bitmaps represent full membership information, as described in further detail elsewhere herein, including with reference to FIG. 5.

FIG. 5 shows an example of a membership data structure configuration 500 that supports user indexing for identifying access to sensitive data in accordance with aspects of the present disclosure. The membership data structure configuration 500 may implement or be implemented by aspects of the computing environments 100 and 200, the unique value configuration 300, the hierarchical structure of principals 400, or any combination thereof, as described with reference to FIGS. 1-4. For example, the membership data structure configuration 500 illustrates examples of membership data structures 515 for multiple principals 510 within a snapshot of an IMS, which may represent examples of membership data structures, principals, and an IMS as described with reference to FIGS. 1-4.

A DMS may obtain a snapshot of an IMS, assign unique values to the principals included in the snapshot, and perform a graph traversal to identify a hierarchical structure of the principals in the snapshot, as described with reference to FIGS. 1-4. The DMS may generate membership data structures 515 for each principal based on the unique values and the graph traversal procedure. A membership data structure 515 may be referred to as a descendant bitmap in some examples herein. The membership data structure 515 may correspond to a bitmap including a quantity of bits that is equal to a quantity of principals 510 in the snapshot of the IMS (e.g., N bits and N principals 510). The membership data structure 515 may include one or more bits set to a first value (e.g., to one) and remaining bits set to a second value (e.g., to zero). The various bit settings may indicate which principals 510 in the IMS are descendants of or members of the corresponding principal 510 in the snapshot of the IMS. For example, each bit that is set to the first value may represent a corresponding principal 510 based on the unique values and corresponding bit positions assigned to the principals 510, as described with reference to FIG. 3. The membership data structure 515 may indicate direct descendants, indirect descendants, or both.

In the example of FIG. 5, the principal 510-a may be associated with the membership data structure 515-a, which may include at least six bits set to the first value. Although not completely illustrated in FIG. 5, in one example, the membership data structure 515-a may include all bits set to the first value. In such an example, all principals 510 of the snapshot of the IMS may be members of the principal 510-a (e.g., a group). For example, the principal 510-a may represent an example of the group 425-a illustrated in FIG. 4. The principal 510-a may thereby be a highest or largest group in the snapshot of the IMS. The DMS may generate the membership data structure 515-a by performing multiple union procedures as part of the graph traversal. For example, the DMS may perform a bitwise OR operation to combine membership data structures at each level of the hierarchy, until the DMS reaches a highest level, which may correspond to the principal 510-a.

The principal 510-b illustrated in FIG. 5 may be associated with the membership data structure 515-b. The membership data structure 515-b may include a single bit set to the first value and remaining bits set to the second value. The single bit may correspond to a unique value for the principal 510-b. For example, the principal 510-b may be assigned to a unique value that corresponds to a second bit position in the bit map, such as the unique value 305-b described with reference to FIG. 3. In this example, because the membership data structure 515-b includes only a single bit set to the first value, it may be understood that the principal 510-b does not include any descendants. That is, the principal 510-b may correspond to a user, such as one of the users 420 illustrated in FIG. 4.

The principal 510-n illustrated in FIG. 5 may be associated with the membership data structure 515-n. The membership data structure 515-n may include two bits set to the first value and remaining bits set to the second value. One of the two bits may correspond to a unique value for the principal 510-n. For example, the principal 510-n may be assigned to a unique value that corresponds to a final bit position in the bit map, such as the unique value 305-n described with reference to FIG. 3. Another of the two bits that is set to the first value in the membership data structure 515-n may indicate a second principal (e.g., user) that is a member of the principal 510-c. For example, the bit in the second bit position of the bitmap may be set to the first value, which may indicate that the principal 510-b is a member of the principal 510-n (e.g., because the second bit position is assigned to the principal 510-b). For example, the principal 510-b may represent an example of the user 420-a illustrated in FIG. 4, and the principal 510-n may represent an example of the group 425-b illustrated in FIG. 4. The membership data structure 515-n may be generated by performing a union between the membership data structure 515-b for the principal 510-b and a second bitmap that represents the principal 510-n. The union may be performed based on direct membership information for the principal 510-b indicating the principal 510-n, as described with reference to FIG. 4.

The DMS may thereby generate complete membership data structures 515 for each principal 510 included in the snapshot of the IMS based on the graph traversal procedure and the unique values for the principals 510. A membership data structure 515 for a given principal 510 may indicate one or more other principals that are direct or indirect members of the principal 510. If the principal 510 is a user, the membership data structure 515 may indicate a single member (e.g., the user). If the principal 510 is a group, the membership data structure 515 may indicate the principal 510 and one or more other principals (e.g., groups or users) that are members of the group.

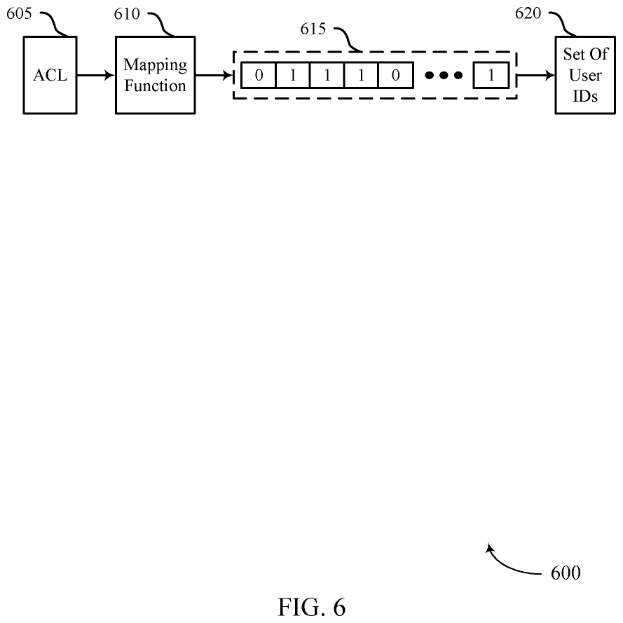

The DMS may thereby utilize the unique values and graph traversal algorithm to efficiently compute all descendants for all groups in the snapshot of the IMS. The DMS may store the membership data structures 515 in storage or some other location and may utilize the membership data structures 515 to identify users that have access to a given computing object, as described in further detail elsewhere herein, including with reference to FIG. 6.

FIG. 6 shows an example of an ACL-to-principal conversion 600 that supports user indexing for identifying access to sensitive data in accordance with aspects of the present disclosure. The ACL-to-principal conversion may implement or be implemented by aspects of the computing environments 100 and 200, the unique value configuration 300, the hierarchical structure of principals 400, the membership data structure configuration 500, or any combination thereof, as described with reference to FIGS. 1-5. For example, the ACL-to-principal conversion 600 illustrates an example of an ACL 605 for a given computing object that is converted to a set of user IDs 620.

The DMS may obtain the ACL 605 for the computing object from a snapshot of a set of computing objects (e.g., a snapshot of client data). Each computing object of a client may be associated with (e.g., assigned to) a respective ACL 605, which may include a set of permissions (e.g., access control entries (ACEs)) for accessing the computing object. The permissions may include approvals and denials for accessing the computing object (e.g., allow or deny permissions). The access approvals and access denials may be evaluated in sequential order. That is, permissions that appear first in the sequential order of the ACL 605 may take precedence over subsequent permissions. Whether a certain principal is allowed to access the computing object may be based on the principal's position in the sequential order of the ACL 605. As an example, if the ACL 605 indicates a group is allowed followed by a denial of a user within the group (e.g., Allow (group) followed by Deny (user)), the user will still have access to the computing object because the access approval precedes the access denial in the order. However, if the ACL 605 indicates that the user is denied followed by the approval for the group's access (e.g., Deny (user); Allow (group)), the user may not have access to the computing object because the access denial precedes the access approval in the order.

Although the ACL 605 indicates a set of permissions for accessing the computing object, it may be beneficial to convert the sequential order of permissions to a set of principals and ultimately specific users to output to a customer. Accordingly, the DMS as described herein may generate a mapping function 610 based on the ACL 605. A mapping function 610 may represent an example of a Boolean expression. Inputting the descendant bitmaps described with reference to FIG. 5 into the mapping function 610 for a given computing object may yield a set of one or more users that are permitted to access the computing object.

To represent the ACL 605 as a mapping function 610, the DMS may first partition the ACL 605 on each deny entry in the ACL. Each partition of the ACL may be referred to as a subset of permissions, in some examples. Each partition may start with a deny ACE followed by one or more allow ACEs. The DMS may generate a respective logical expression for each partition of the ACL 605. The DMS may perform a NOT of the denial and may perform a bitwise OR operation for each of the allowances. The DMS may then combine, via an AND operation, the negated denial and the combined allowances to generate the logical function for the partition. That is, for each partition, the DMS may set (!Deny && (OR of all Allow)) to prevent denied principals and their descendants from getting access. For a partition that includes [D1, A2, A3], a corresponding logical function may, for example, be represented as (!D1 & (A2∥A3)). The DMS may subsequently perform an OR operation between the logical functions for all partitions of the ACL 605 to identify all principals that have access to a given computing object.

As an example, the ACL 605 may be [A1, D1, A2, A3, D2, A4], where A may represent an allow and D may represent a deny. The DMS may divide the ACL 605 into three subsets by partitioning the ACL 605 on each deny. A first subset may include A1, a second subset may include [D1, A2, A3], and a third subset may include [D2, A4]. The DMS may generate the mapping function 610 for the ACL as follows: (A1)∥(!D1 & (A2∥A3))∥(!D2 & A4).

After generating the mapping function 610, the DMS may input the descendant bitmap associated with each ACE into the mapping function 610 to produce a bitmap 615 that represents a set of permitted principals. For example, each ACE may indicate an ID of a corresponding principal (e.g., A1 may indicate an ID of a first principal, A2 may indicate an ID of a second principal, and the like). The DMS may identify a descendant bitmap for the corresponding principal, which may be a membership data structure for the principal, as described in further detail elsewhere herein, including with reference to FIG. 5. The DMS may input the membership data structures into the mapping function 610 and may calculate a result of the function based on bitwise logical operations.

The resulting bitmap 615 may include a same quantity of bits as a quantity of principals in the snapshot of the IMS, and one or more bits may be set to a first value (e.g., one). The one or more bits set to the first value may indicate a set of principals that have access to (e.g., are permitted to access) the corresponding computing object. For example, if a second bit position is set to the first value, a principal having a unique value that is associated with the second bit position, as described with reference to FIG. 3, may be permitted to access the computing object.

The DMS may convert the bitmap 615 into a set of user IDs 620 to output to a customer. The DMS may utilize the unique values described herein to perform the conversion (e.g., a rank to principal mapping). For example, the DMS may utilize a rank to principal mapping in storage to convert each bit position that is set to the first value to an ID of a corresponding principal. After converting the bitmap 615 back into the set of user IDs 620, the DMS may display the set of user IDs 620 to a customer.

The DMS may perform such ACL-to-principal conversions for one or more computing objects. The DMS may thereby identify IDs of users that have access to given computing object and may output the IDs to a customer via a user interface. In some examples, the DMS may additionally output secureness information associated with each user, such that the customer may take proactive measures to limit access and secure data as needed. For example, the DMS may determine whether a given user is part of an open access group, has a password that does not expire, does not have any password policies set, one or more other secureness checks, or any combination thereof. The DMS may determine a secureness level for the user based on the various secureness checks. The DMS may output the secureness level to a client. The client may thereby determine which users have access to data, and how secure such users may be. The data may include sensitive data, in some examples, such as PII, personal medical information, or other sensitive or high risk data.

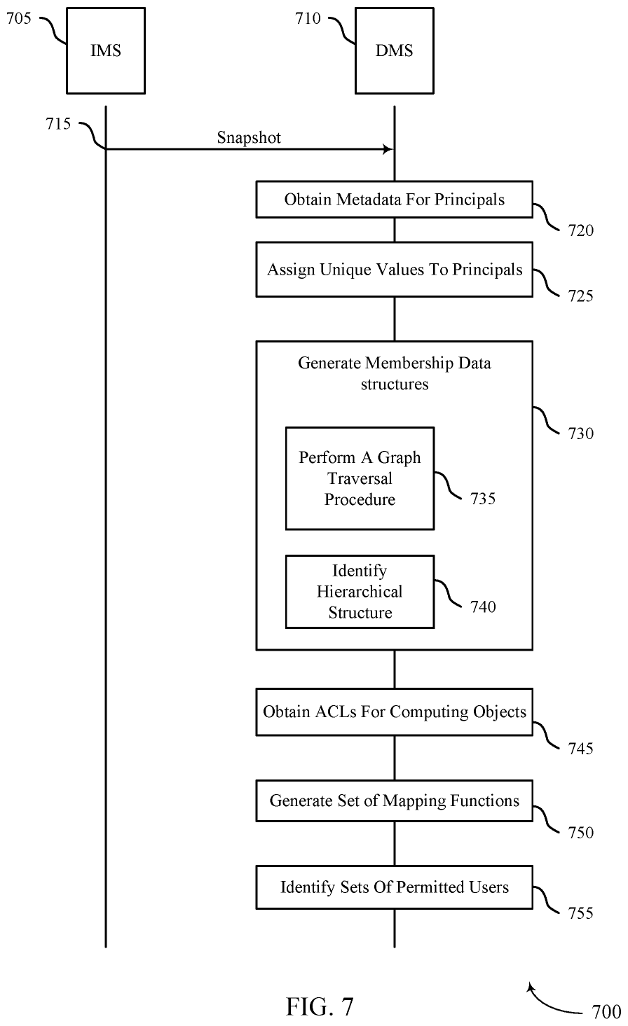

FIG. 7 shows an example of a process flow 700 that supports user indexing for identifying access to sensitive data in accordance with aspects of the present disclosure. The process flow 700 may implement or be implemented by aspects of the computing environments 100 and 200, the unique value configuration 300, the hierarchical structure of principals 400, the membership data structure configuration 500, the ACL-to-principal conversion 600, or any combination thereof, as described with reference to FIGS. 1-6. For example, the process flow 700 illustrates actions taken by a DMS 710 to index and access principal information of an IMS 705, where the DMS 710 and the IMS 705 may represent examples of corresponding systems as described with reference to FIGS. 1-6.

In some aspects, the operations illustrated in the process flow 700 may be performed by hardware (e.g., including circuitry, processing blocks, logic components, and other components), code (e.g., software or firmware) executed by a processor, or any combination thereof. For example, aspects of the process flow 700 may be implemented or managed by a DMS 710, a user index component, or some other software or application that is associated with data backup and recovery.

In the following description of the process flow 700, the operations by the IMS 705 and the DMS 710 may be performed in different orders or at different times. Some operations may also be left out of the process flow 700, or other operations may be added. Although the IMS 705 and the DMS 710 are shown performing the operations of the process flow 700, some aspects of some operations may also be performed by one or more other components or systems.

At 715, the DMS 710 may obtain a snapshot of the IMS 705. The IMS 705 may govern access to a set of computing objects for a set of principals. For example, the IMS 705 may authorize principals and provide access to the set of computing objects. The set of principals may include users and groups of users. The DMS 710 may obtain the snapshot of the IMS 705 directly (e.g., if the IMS 705 executes n a cloud environment) or from a CDM (e.g., if the IMS 705 executes in-network), as described with reference to FIG. 2.

At 720, the DMS 710 may obtain metadata for the set of principals based on information included in the snapshot. The metadata may represent an example of UMD, as described in further detail elsewhere herein, including with reference to FIGS. 2-6. In some examples, the metadata for a principal may include direct group membership information for the principal, one or more secureness attributes of the principal, one or more other parameters, or any combination thereof. The direct group membership information for a principal may indicate one or more groups of which the principal is a direct member.

At 725, the DMS 710 may assign unique values to the set of principals. The DMS 710 may assign a respective unique value to each principal included in the snapshot of the IMS 705. The unique values may be assigned based on IDs of the principals and the metadata associated with the principals, as described in further detail elsewhere herein, including with reference to FIG. 3.

At 730, the DMS 710 may generate membership data structures for the set of principals. A membership data structure for a given principal may indicate one or more other principals that descend from the corresponding principal. For example, a membership data structure (e.g., a descendant bitmap) may indicate one or more users or one or more groups that are included in the principal. The membership data structures may represent examples of the membership data structures 515 described with reference to FIG. 5.

In some examples, to generate the membership data structures, at 735, the DMS 710 may perform a graph traversal procedure for the set of principals. In some examples, performing the graph traversal procedure may include, at 740, the DMS 710 identifying, based on the direct group membership information included in the metadata for the set of principals, a hierarchical structure including dependency chains between principals, such as the hierarchical structure of principals 400 described with reference to FIG. 4. The DMS 710 may generate the membership data structures based on the graph traversal procedure, the hierarchical structure, and the unique values. For example, the DMS 710 may generate bitmaps that indicate one or more principals that descend from a corresponding principal based on a set of one or more unique values that are set in the bitmap.

At 745, the DMS may obtain ACLs for the set of computing objects. The DMS 710 may obtain the ACLs from a snapshot of the set of computing objects. An ACL may indicate, for a respective computing object, a set of one or more access approvals, one or more access denials, or any combination thereof for one or more associated principals. Whether a given principal is permitted to access the computing object may depend on a sequential order of approvals and denials in the ACL.

At 750, to convert the ACLs to a set of principals, the DMS 710 may generate a set of mapping functions based on the ACLs. Applying a mapping function for an ACL to one or more membership data structures for one or more principals associated with the ACL may yield a set of one or more permitted users. The set of one or more permitted users may have access to a computing object that is associated with the ACL.

At 755, the DMS 710 may identify, for the set of computing objects, respective sets of one or more permitted users. For example, the DMS 710 may input the membership data structures for the principals into a mapping function for a given computing object and may perform logical bitwise operations according to the mapping function to generate a resulting bitmap. The resulting bitmap may indicate a set of permitted principals for the computing object. The DMS 710 may utilize the unique values to convert the bitmap into a set of user IDs associated with the set of permitted users. In some examples, the DMS 710 may output the set of user IDs to a client to indicate which users have access to the computing object. The DMS 710 may, in some examples, additionally output a secureness level associated with the users. The secureness level may be based on one or more secureness attributes associated with the user. The client may thereby identify which users have access to client data, which may include potentially sensitive or high risk data. The client may take one or more actions to adjust permissions and accesses accordingly to improve reliability and security of the data.

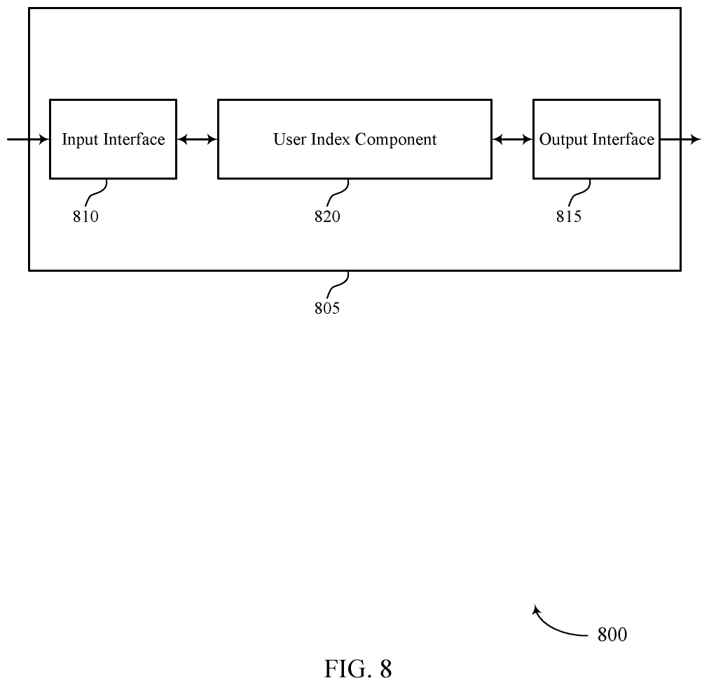

FIG. 8 shows a block diagram 800 of a system 805 that supports user indexing for identifying access to sensitive data in accordance with aspects of the present disclosure. The system 805 may be an example of aspects of a DMS as described herein. The system 805 may include an input interface 810, an output interface 815, and a user index component 820. The system 805, or one or more components of the system 805 (e.g., the input interface 810, the output interface 815, and the user index component 820), may include at least one processor, which may be coupled with at least one memory, to, individually or collectively, support or enable the described techniques. Each of these components may be in communication with one another (e.g., via one or more buses).

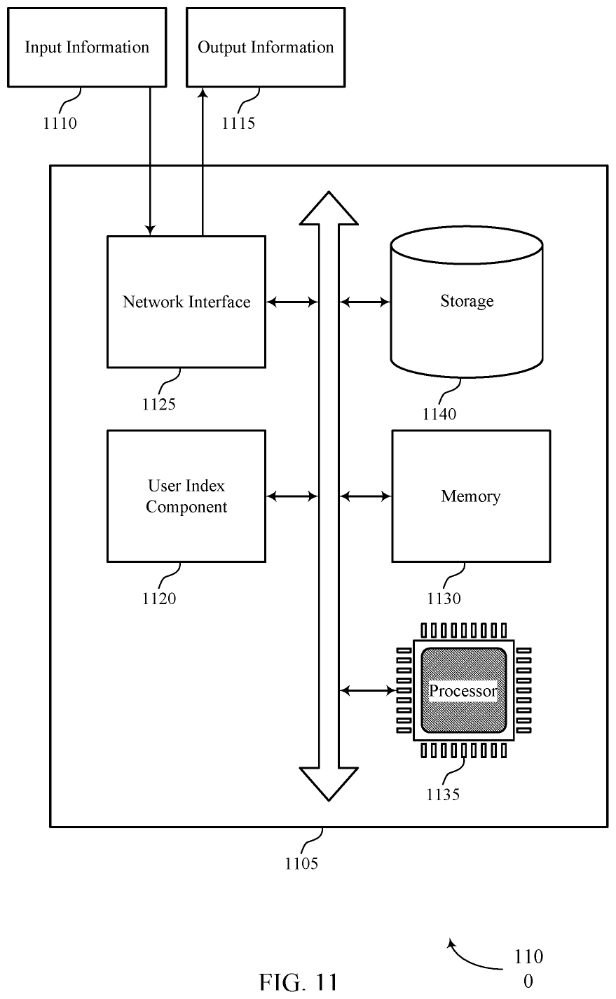

The input interface 810 may manage input signaling for the system 805. For example, the input interface 810 may receive input signaling (e.g., messages, packets, data, instructions, commands, or any other form of encoded information) from other systems or devices. The input interface 810 may send signaling corresponding to (e.g., representative of or otherwise based on) such input signaling to other components of the system 805 for processing. For example, the input interface 810 may transmit such corresponding signaling to the user index component 820 to support user indexing for identifying access to sensitive data. In some cases, the input interface 810 may be a component of a network interface 1125 as described with reference to FIG. 11.

The output interface 815 may manage output signaling for the system 805. For example, the output interface 815 may receive signaling from other components of the system 805, such as the user index component 820, and may transmit such output signaling corresponding to (e.g., representative of or otherwise based on) such signaling to other systems or devices. In some cases, the output interface 815 may be a component of a network interface 1125 as described with reference to FIG. 11.

The user index component 820, the input interface 810, the output interface 815, or various combinations thereof or various components thereof may be examples of means for performing various aspects of user indexing for identifying access to sensitive data as described herein. For example, the user index component 820, the input interface 810, the output interface 815, or various combinations or components thereof may be capable of performing one or more of the functions described herein.

In some examples, the user index component 820, the input interface 810, the output interface 815, or various combinations or components thereof may be implemented in hardware (e.g., in communications management circuitry). The hardware may include at least one of a processor, a DSP, an ASIC, an FPGA or other programmable logic device, a discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the user index component 820, the input interface 810, the output interface 815, or various combinations or components thereof may be implemented in code (e.g., as communications management software or firmware) executed by at least one processor. If implemented in code executed by at least one processor, the functions of the user index component 820, the input interface 810, the output interface 815, or various combinations or components thereof may be performed by a general-purpose processor, a DSP, a CPU, an ASIC, an FPGA, or any combination of these or other programmable logic devices (e.g., configured as or otherwise supporting, individually or collectively, a means for performing the functions described in the present disclosure).

In some examples, the user index component 820 may be configured to perform various operations (e.g., receiving, monitoring, transmitting) using or otherwise in cooperation with the input interface 810, the output interface 815, or both. For example, the user index component 820 may receive information from the input interface 810, send information to the output interface 815, or be integrated in combination with the input interface 810, the output interface 815, or both to receive information, transmit information, or perform various other operations as described herein.

For example, the user index component 820 may be configured as or otherwise support a means for obtaining a snapshot of an IMS that governs access to a set of computing objects for a set of multiple principals, the set of multiple principals including users and groups of users. The user index component 820 may be configured as or otherwise support a means for obtaining metadata for the set of multiple principals based on information included in the snapshot, where the metadata for a principal includes direct group membership information that indicates one or more groups of which the principal is a direct member. The user index component 820 may be configured as or otherwise support a means for assigning a set of multiple unique values to the set of multiple principals. The user index component 820 may be configured as or otherwise support a means for performing a graph traversal procedure for the set of multiple principals, where performing the graph traversal procedure includes identifying, based on the direct group membership information included in the metadata for the set of multiple principals, a hierarchical structure including dependency chains between principals. The user index component 820 may be configured as or otherwise support a means for generating, based on performing the graph traversal procedure, a set of multiple membership data structures for the set of multiple principals, where a membership data structure indicates one or more principals that descend from a corresponding principal based on a set of one or more unique values, from among the set of multiple unique values, corresponding to the one or more descendant principals.

By including or configuring the user index component 820 in accordance with examples as described herein, the system 805 (e.g., at least one processor controlling or otherwise coupled with the input interface 810, the output interface 815, the user index component 820, or a combination thereof) may support techniques for reduced processing, reduced power consumption, and improved utilization of computing resources, among other possibilities.

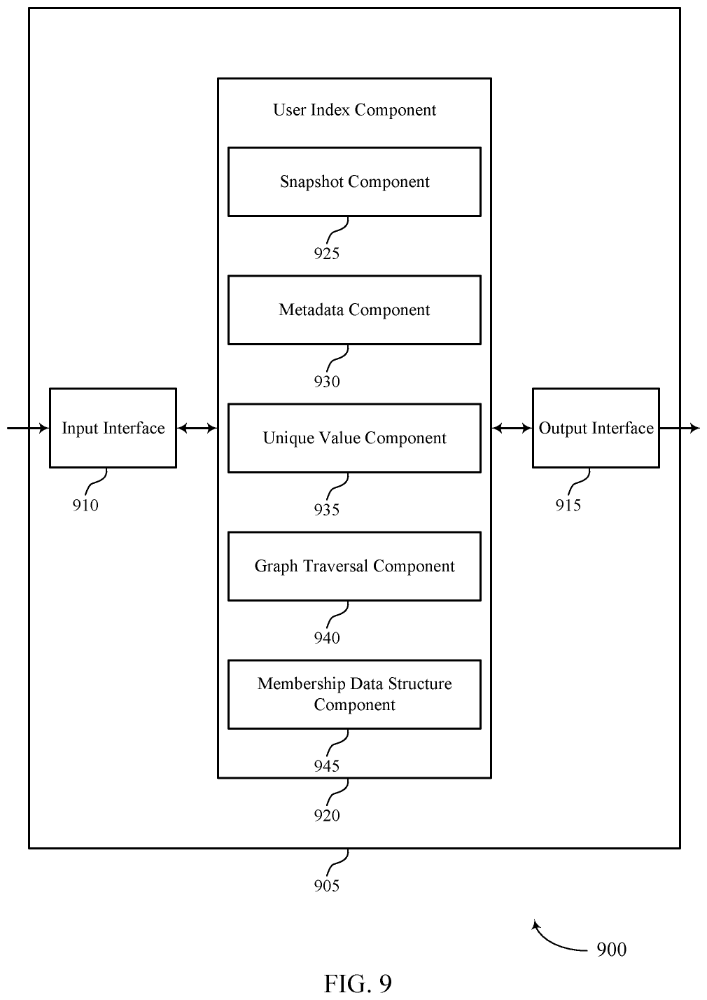

FIG. 9 shows a block diagram 900 of a system 905 that supports user indexing for identifying access to sensitive data in accordance with aspects of the present disclosure. In some examples, the system 905 may be an example of aspects of one or more components described with reference to FIG. 1, such as a DMS 110. The system 905 may be an example of aspects of a system 805 or a DMS 110 as described herein. The system 905 may include an input interface 910, an output interface 915, and a user index component 920. The system 905 may also include one or more processors. Each of these components may be in communication with one another (e.g., via one or more buses, communications links, communications interfaces, or any combination thereof).

The input interface 910 may manage input signaling for the system 905. For example, the input interface 910 may receive input signaling (e.g., messages, packets, data, instructions, commands, or any other form of encoded information) from other systems or devices. The input interface 910 may send signaling corresponding to (e.g., representative of or otherwise based on) such input signaling to other components of the system 905 for processing. For example, the input interface 910 may transmit such corresponding signaling to the user index component 920 to support user indexing for identifying access to sensitive data. In some cases, the input interface 910 may be a component of a network interface 1125 as described with reference to FIG. 11.

The output interface 915 may manage output signaling for the system 905. For example, the output interface 915 may receive signaling from other components of the system 905, such as the user index component 920, and may transmit such output signaling corresponding to (e.g., representative of or otherwise based on) such signaling to other systems or devices. In some cases, the output interface 915 may be a component of a network interface 1125 as described with reference to FIG. 11.

The system 905, or various components thereof, may be an example of means for performing various aspects of user indexing for identifying access to sensitive data as described herein. For example, the user index component 920 may include a snapshot component 925, a metadata component 930, a unique value component 935, a graph traversal component 940, a membership data structure component 945, or any combination thereof. The user index component 920 may be an example of aspects of a user index component 820 as described herein. In some examples, the user index component 920, or various components thereof, may be configured to perform various operations (e.g., receiving, monitoring, transmitting) using or otherwise in cooperation with the input interface 910, the output interface 915, or both. For example, the user index component 920 may receive information from the input interface 910, send information to the output interface 915, or be integrated in combination with the input interface 910, the output interface 915, or both to receive information, transmit information, or perform various other operations as described herein.

The snapshot component 925 may be configured as or otherwise support a means for obtaining a snapshot of an IMS that governs access to a set of computing objects for a set of multiple principals, the set of multiple principals including users and groups of users. The metadata component 930 may be configured as or otherwise support a means for obtaining metadata for the set of multiple principals based on information included in the snapshot, where the metadata for a principal includes direct group membership information that indicates one or more groups of which the principal is a direct member. The unique value component 935 may be configured as or otherwise support a means for assigning a set of multiple unique values to the set of multiple principals. The graph traversal component 940 may be configured as or otherwise support a means for performing a graph traversal procedure for the set of multiple principals, where performing the graph traversal procedure includes identifying, based on the direct group membership information included in the metadata for the set of multiple principals, a hierarchical structure including dependency chains between principals. The membership data structure component 945 may be configured as or otherwise support a means for generating, based on performing the graph traversal procedure, a set of multiple membership data structures for the set of multiple principals, where a membership data structure indicates one or more principals that descend from a corresponding principal based on a set of one or more unique values, from among the set of multiple unique values, corresponding to the one or more descendant principals.

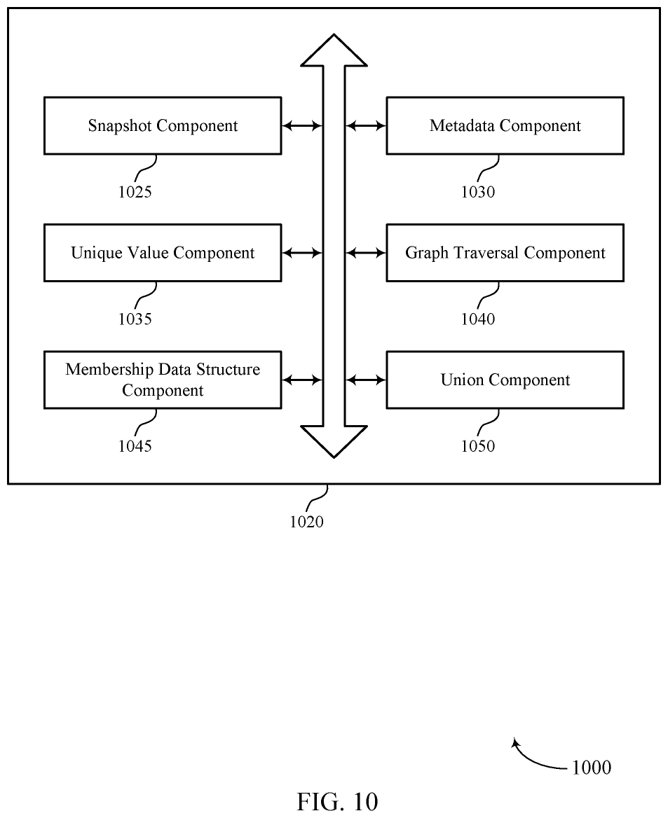

FIG. 10 shows a block diagram 1000 of a user index component 1020 that supports user indexing for identifying access to sensitive data in accordance with aspects of the present disclosure. The user index component 1020 may be an example of aspects of a user index component 820, a user index component 920, or both, as described herein. The user index component 1020, or various components thereof, may be an example of means for performing various aspects of user indexing for identifying access to sensitive data as described herein. For example, the user index component 1020 may include a snapshot component 1025, a metadata component 1030, a unique value component 1035, a graph traversal component 1040, a membership data structure component 1045, a union component 1050, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The snapshot component 1025 may be configured as or otherwise support a means for obtaining a snapshot of an IMS that governs access to a set of computing objects for a set of multiple principals, the set of multiple principals including users and groups of users. The metadata component 1030 may be configured as or otherwise support a means for obtaining metadata for the set of multiple principals based on information included in the snapshot, where the metadata for a principal includes direct group membership information that indicates one or more groups of which the principal is a direct member. The unique value component 1035 may be configured as or otherwise support a means for assigning a set of multiple unique values to the set of multiple principals. The graph traversal component 1040 may be configured as or otherwise support a means for performing a graph traversal procedure for the set of multiple principals, where performing the graph traversal procedure includes identifying, based on the direct group membership information included in the metadata for the set of multiple principals, a hierarchical structure including dependency chains between principals. The membership data structure component 1045 may be configured as or otherwise support a means for generating, based on performing the graph traversal procedure, a set of multiple membership data structures for the set of multiple principals, where a membership data structure indicates one or more principals that descend from a corresponding principal based on a set of one or more unique values, from among the set of multiple unique values, corresponding to the one or more descendant principals.

In some examples, to support performing an iteration of the set of multiple iterations, the metadata component 1030 may be configured as or otherwise support a means for identifying, for a first set of principals from among the set of multiple principals identified from the snapshot of the IMS, a respective subset of metadata that corresponds to the first set of principals, where the respective subset of metadata includes a respective subset of direct group membership information that indicates one or more groups of which principals in the first set of principals are direct members from within the hierarchical structure of the set of multiple principals. In some examples, to support performing an iteration of the set of multiple iterations, the union component 1050 may be configured as or otherwise support a means for performing, for the first set of principals and based on identifying the one or more groups, one or more union procedures to generate one or more membership data structures of the set of multiple membership data structures, the one or more membership data structures for the one or more groups identified in the respective subset of direct group membership information for the first set of principals.

In some examples, to support performing the graph traversal procedure, the graph traversal component 1040 may be configured as or otherwise support a means for performing, after performing the iteration, one or more second iterations of the set of multiple iterations until respective direct group membership information for all of the set of multiple principals is identified and the set of multiple membership data structures for the set of multiple principals is generated.

In some examples, to support performing a union procedure of the one or more union procedures, the union component 1050 may be configured as or otherwise support a means for combining, in accordance with a logical OR operation, a first membership bitmap associated with a first principal from among the first set of principals with a second membership bitmap associated with a second principal from among the one or more groups, where combining the first membership bitmap and the second membership bitmap is based on identifying that the first principal is a direct member of the second principal within the hierarchical structure, and where the first membership bitmap indicates at least the first principal and the second membership bitmap indicates at least the second principal and one or more other principals that are descendants from the second principal in the hierarchical structure. In some examples, to support performing a union procedure of the one or more union procedures, the membership data structure component 1045 may be configured as or otherwise support a means for generating a first membership data structure for the second principal based on combining the second membership bitmap with the first membership bitmap and one or more other membership bitmaps associated with one or more other principals, from among the first set of principals, that are direct members of the second principal within the hierarchical structure.

In some examples, the first set of principals includes a set of multiple users within the IMS.

In some examples, to support assigning a unique value of the set of multiple unique values, the unique value component 1035 may be configured as or otherwise support a means for identifying a unique ID of a principal from among the set of multiple principals identified from the snapshot. In some examples, to support assigning a unique value of the set of multiple unique values, the unique value component 1035 may be configured as or otherwise support a means for assigning a unique value to the principal based on identifying the unique ID for the principal, where the unique value includes an integer that corresponds to a position in a bitmap, and where the position is representative of the principal.

In some examples, a quantity of bits in the bitmap is greater than or equal to a quantity of the set of multiple principals identified from the snapshot. In some examples, a position of a bit in the quantity of bits corresponds to a respective unique value for a respective principal of the set of multiple principals.

In some examples, the unique value is based on an order in which the unique ID for the principal is identified relative to other unique IDs being identified for other principals of the set of multiple principals identified from the snapshot.

In some examples, to support generating a membership data structure of the set of multiple membership data structures, the membership data structure component 1045 may be configured as or otherwise support a means for generating, for a principal of the set of multiple principals, a membership bitmap that includes a quantity of bits, where one or more bits of the quantity of bits are set to a first value and remaining bits of the quantity of bits are set to a second value within the membership bitmap, the one or more bits set to the first value associated with one or more respective unique values of the set of multiple unique values that are assigned to the principal and one or more other principals that descend from the principal in the hierarchical structure, where the quantity of bits in the membership bitmap is equal to a quantity of principals of the set of multiple principals identified from the snapshot of the IMS.

FIG. 11 shows a block diagram 1100 of a system 1105 that supports user indexing for identifying access to sensitive data in accordance with aspects of the present disclosure. The system 1105 may be an example of or include the components of a system 805, a system 905, or a DMS as described herein. The system 1105 may include components for data management, including components such as a user index component 1120, an input information 1110, an output information 1115, a network interface 1125, at least one memory 1130, at least one processor 1135, and a storage 1140. These components may be in electronic communication or otherwise coupled with each other (e.g., operatively, communicatively, functionally, electronically, electrically; via one or more buses, communications links, communications interfaces, or any combination thereof). Additionally, the components of the system 1105 may include corresponding physical components or may be implemented as corresponding virtual components (e.g., components of one or more virtual machines). In some examples, the system 1105 may be an example of aspects of one or more components described with reference to FIG. 1, such as a DMS 110.

The network interface 1125 may enable the system 1105 to exchange information (e.g., input information 1110, output information 1115, or both) with other systems or devices (not shown). For example, the network interface 1125 may enable the system 1105 to connect to a network (e.g., a network 120 as described herein). The network interface 1125 may include one or more wireless network interfaces, one or more wired network interfaces, or any combination thereof. In some examples, the network interface 1125 may be an example of may be an example of aspects of one or more components described with reference to FIG. 1, such as one or more network interfaces 165.

Memory 1130 may include RAM, ROM, or both. The memory 1130 may store computer-readable, computer-executable software including instructions that, when executed, cause the processor 1135 to perform various functions described herein. In some cases, the memory 1130 may contain, among other things, a basic input/output system (BIOS), which may control basic hardware or software operation such as the interaction with peripheral components or devices. In some cases, the memory 1130 may be an example of aspects of one or more components described with reference to FIG. 1, such as one or more memories 175.

The processor 1135 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 1135 may be configured to execute computer-readable instructions stored in a memory 1130 to perform various functions (e.g., functions or tasks supporting user indexing for identifying access to sensitive data). Though a single processor 1135 is depicted in the example of FIG. 11, it is to be understood that the system 1105 may include any quantity of one or more of processors 1135 and that a group of processors 1135 may collectively perform one or more functions ascribed herein to a processor, such as the processor 1135. In some cases, the processor 1135 may be an example of aspects of one or more components described with reference to FIG. 1, such as one or more processors 170.

Storage 1140 may be configured to store data that is generated, processed, stored, or otherwise used by the system 1105. In some cases, the storage 1140 may include one or more HDDs, one or more SDDs, or both. In some examples, the storage 1140 may be an example of a single database, a distributed database, multiple distributed databases, a data store, a data lake, or an emergency backup database. In some examples, the storage 1140 may be an example of one or more components described with reference to FIG. 1, such as one or more network disks 180.

For example, the user index component 1120 may be configured as or otherwise support a means for obtaining a snapshot of an IMS that governs access to a set of computing objects for a set of multiple principals, the set of multiple principals including users and groups of users. The user index component 1120 may be configured as or otherwise support a means for obtaining metadata for the set of multiple principals based on information included in the snapshot, where the metadata for a principal includes direct group membership information that indicates one or more groups of which the principal is a direct member. The user index component 1120 may be configured as or otherwise support a means for assigning a set of multiple unique values to the set of multiple principals. The user index component 1120 may be configured as or otherwise support a means for performing a graph traversal procedure for the set of multiple principals, where performing the graph traversal procedure includes identifying, based on the direct group membership information included in the metadata for the set of multiple principals, a hierarchical structure including dependency chains between principals. The user index component 1120 may be configured as or otherwise support a means for generating, based on performing the graph traversal procedure, a set of multiple membership data structures for the set of multiple principals, where a membership data structure indicates one or more principals that descend from a corresponding principal based on a set of one or more unique values, from among the set of multiple unique values, corresponding to the one or more descendant principals.

By including or configuring the user index component 1120 in accordance with examples as described herein, the system 1105 may support techniques for user indexing for identifying access to sensitive data, which may provide one or more benefits such as, for example, improved reliability, reduced latency, more efficient utilization of computing resources, network resources or both, improved scalability, or improved security, among other possibilities.

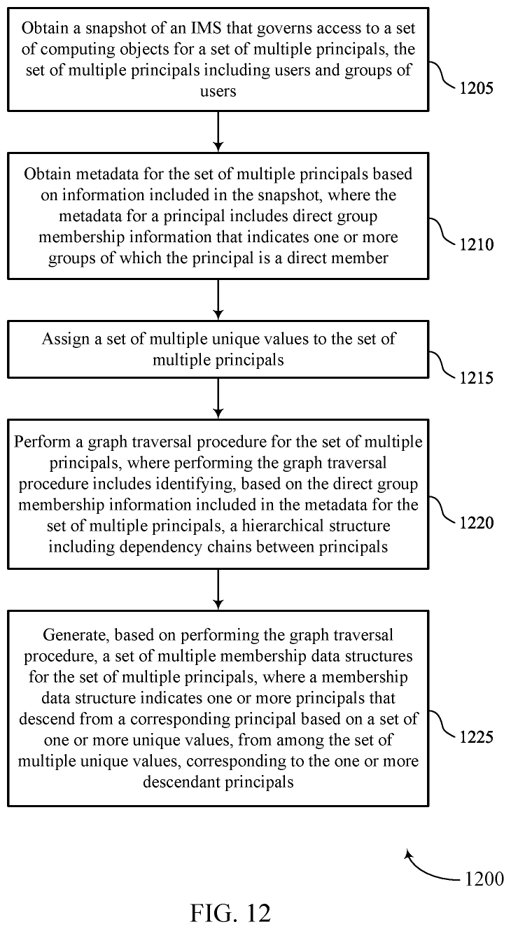

FIG. 12 shows a flowchart illustrating a method 1200 that supports user indexing for identifying access to sensitive data in accordance with aspects of the present disclosure. The operations of the method 1200 may be implemented by a DMS or its components as described herein. For example, the operations of the method 1200 may be performed by a DMS as described with reference to FIGS. 1 through 11. In some examples, a DMS may execute a set of instructions to control the functional elements of the DMS to perform the described functions. Additionally, or alternatively, the DMS may perform aspects of the described functions using special-purpose hardware.

At 1205, the method may include obtaining a snapshot of an IMS that governs access to a set of computing objects for a set of multiple principals, the set of multiple principals including users and groups of users. The operations of block 1205 may be performed in accordance with examples as disclosed herein. In some examples, aspects of the operations of 1205 may be performed by a snapshot component 1025 as described with reference to FIG. 10.

At 1210, the method may include obtaining metadata for the set of multiple principals based on information included in the snapshot, where the metadata for a principal includes direct group membership information that indicates one or more groups of which the principal is a direct member. The operations of block 1210 may be performed in accordance with examples as disclosed herein. In some examples, aspects of the operations of 1210 may be performed by a metadata component 1030 as described with reference to FIG. 10.

At 1215, the method may include assigning a set of multiple unique values to the set of multiple principals. The operations of block 1215 may be performed in accordance with examples as disclosed herein. In some examples, aspects of the operations of 1215 may be performed by a unique value component 1035 as described with reference to FIG. 10.

At 1220, the method may include performing a graph traversal procedure for the set of multiple principals, where performing the graph traversal procedure includes identifying, based on the direct group membership information included in the metadata for the set of multiple principals, a hierarchical structure including dependency chains between principals. The operations of block 1220 may be performed in accordance with examples as disclosed herein. In some examples, aspects of the operations of 1220 may be performed by a graph traversal component 1040 as described with reference to FIG. 10.

At 1225, the method may include generating, based on performing the graph traversal procedure, a set of multiple membership data structures for the set of multiple principals, where a membership data structure indicates one or more principals that descend from a corresponding principal based on a set of one or more unique values, from among the set of multiple unique values, corresponding to the one or more descendant principals. The operations of block 1225 may be performed in accordance with examples as disclosed herein. In some examples, aspects of the operations of 1225 may be performed by a membership data structure component 1045 as described with reference to FIG. 10.

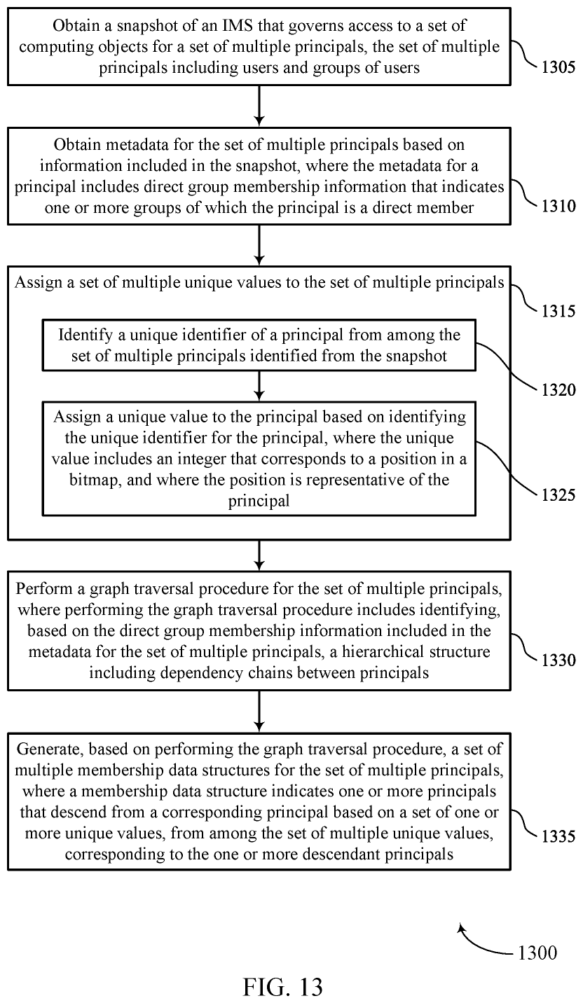

FIG. 13 shows a flowchart illustrating a method 1300 that supports user indexing for identifying access to sensitive data in accordance with aspects of the present disclosure. The operations of the method 1300 may be implemented by a DMS or its components as described herein. For example, the operations of the method 1300 may be performed by a DMS as described with reference to FIGS. 1 through 11. In some examples, a DMS may execute a set of instructions to control the functional elements of the DMS to perform the described functions. Additionally, or alternatively, the DMS may perform aspects of the described functions using special-purpose hardware.

At 1305, the method may include obtaining a snapshot of an IMS that governs access to a set of computing objects for a set of multiple principals, the set of multiple principals including users and groups of users. The operations of block 1305 may be performed in accordance with examples as disclosed herein. In some examples, aspects of the operations of 1305 may be performed by a snapshot component 1025 as described with reference to FIG. 10.

At 1310, the method may include obtaining metadata for the set of multiple principals based on information included in the snapshot, where the metadata for a principal includes direct group membership information that indicates one or more groups of which the principal is a direct member. The operations of block 1310 may be performed in accordance with examples as disclosed herein. In some examples, aspects of the operations of 1310 may be performed by a metadata component 1030 as described with reference to FIG. 10.

At 1315, the method may include assigning a set of multiple unique values to the set of multiple principals. The operations of block 1315 may be performed in accordance with examples as disclosed herein. In some examples, aspects of the operations of 1315 may be performed by a unique value component 1035 as described with reference to FIG. 10.

At 1320, to assign a unique value of the set of multiple unique values to a principal, the method may include identifying a unique ID of the principal from among the set of multiple principals identified from the snapshot. The operations of block 1320 may be performed in accordance with examples as disclosed herein. In some examples, aspects of the operations of 1320 may be performed by a unique value component 1035 as described with reference to FIG. 10.

At 1325, to assign the unique value of the set of multiple unique values to the principal, the method may further include assigning the unique value to the principal based on identifying the unique ID for the principal, where the unique value includes an integer that corresponds to a position in a bitmap, and where the position is representative of the principal. The operations of block 1325 may be performed in accordance with examples as disclosed herein. In some examples, aspects of the operations of 1325 may be performed by a unique value component 1035 as described with reference to FIG. 10.

At 1330, the method may include performing a graph traversal procedure for the set of multiple principals, where performing the graph traversal procedure includes identifying, based on the direct group membership information included in the metadata for the set of multiple principals, a hierarchical structure including dependency chains between principals. The operations of block 1330 may be performed in accordance with examples as disclosed herein. In some examples, aspects of the operations of 1330 may be performed by a graph traversal component 1040 as described with reference to FIG. 10.

At 1335, the method may include generating, based on performing the graph traversal procedure, a set of multiple membership data structures for the set of multiple principals, where a membership data structure indicates one or more principals that descend from a corresponding principal based on a set of one or more unique values, from among the set of multiple unique values, corresponding to the one or more descendant principals. The operations of block 1335 may be performed in accordance with examples as disclosed herein. In some examples, aspects of the operations of 1335 may be performed by a membership data structure component 1045 as described with reference to FIG. 10.

A method by an apparatus is described. The method may include obtaining a snapshot of an IMS that governs access to a set of computing objects for a set of multiple principals, the set of multiple principals including users and groups of users, obtaining metadata for the set of multiple principals based on information included in the snapshot, where the metadata for a principal includes direct group membership information that indicates one or more groups of which the principal is a direct member, assigning a set of multiple unique values to the set of multiple principals, performing a graph traversal procedure for the set of multiple principals, where performing the graph traversal procedure includes identifying, based on the direct group membership information included in the metadata for the set of multiple principals, a hierarchical structure including dependency chains between principals, and generating, based on performing the graph traversal procedure, a set of multiple membership data structures for the set of multiple principals, where a membership data structure indicates one or more principals that descend from a corresponding principal based on a set of one or more unique values, from among the set of multiple unique values, corresponding to the one or more descendant principals.

An apparatus is described. The apparatus may include one or more memories storing processor executable code, and one or more processors coupled with the one or more memories. The one or more processors may individually or collectively operable to execute the code to cause the apparatus to obtain a snapshot of an IMS that governs access to a set of computing objects for a set of multiple principals, the set of multiple principals including users and groups of users, obtain metadata for the set of multiple principals based on information included in the snapshot, where the metadata for a principal includes direct group membership information that indicates one or more groups of which the principal is a direct member, assign a set of multiple unique values to the set of multiple principals, perform a graph traversal procedure for the set of multiple principals, where performing the graph traversal procedure includes identifying, based on the direct group membership information included in the metadata for the set of multiple principals, a hierarchical structure including dependency chains between principals, and generate, based on performing the graph traversal procedure, a set of multiple membership data structures for the set of multiple principals, where a membership data structure indicates one or more principals that descend from a corresponding principal based on a set of one or more unique values, from among the set of multiple unique values, corresponding to the one or more descendant principals.

Another apparatus is described. The apparatus may include means for obtaining a snapshot of an IMS that governs access to a set of computing objects for a set of multiple principals, the set of multiple principals including users and groups of users, means for obtaining metadata for the set of multiple principals based on information included in the snapshot, where the metadata for a principal includes direct group membership information that indicates one or more groups of which the principal is a direct member, means for assigning a set of multiple unique values to the set of multiple principals, means for performing a graph traversal procedure for the set of multiple principals, where performing the graph traversal procedure includes identifying, based on the direct group membership information included in the metadata for the set of multiple principals, a hierarchical structure including dependency chains between principals, and means for generating, based on performing the graph traversal procedure, a set of multiple membership data structures for the set of multiple principals, where a membership data structure indicates one or more principals that descend from a corresponding principal based on a set of one or more unique values, from among the set of multiple unique values, corresponding to the one or more descendant principals.

A non-transitory computer-readable medium storing code is described. The code may include instructions executable by a processor to obtain a snapshot of an IMS that governs access to a set of computing objects for a set of multiple principals, the set of multiple principals including users and groups of users, obtain metadata for the set of multiple principals based on information included in the snapshot, where the metadata for a principal includes direct group membership information that indicates one or more groups of which the principal is a direct member, assign a set of multiple unique values to the set of multiple principals, perform a graph traversal procedure for the set of multiple principals, where performing the graph traversal procedure includes identifying, based on the direct group membership information included in the metadata for the set of multiple principals, a hierarchical structure including dependency chains between principals, and generate, based on performing the graph traversal procedure, a set of multiple membership data structures for the set of multiple principals, where a membership data structure indicates one or more principals that descend from a corresponding principal based on a set of one or more unique values, from among the set of multiple unique values, corresponding to the one or more descendant principals.

In some examples of the method, apparatus, and non-transitory computer-readable medium described herein, performing an iteration of the set of multiple iterations may include operations, features, means, or instructions for identifying, for a first set of principals from among the set of multiple principals identified from the snapshot of the IMS, a respective subset of metadata that corresponds to the first set of principals, where the respective subset of metadata includes a respective subset of direct group membership information that indicates one or more groups of which principals in the first set of principals may be direct members from within the hierarchical structure of the set of multiple principals and performing, for the first set of principals and based on identifying the one or more groups, one or more union procedures to generate one or more membership data structures of the set of multiple membership data structures, the one or more membership data structures for the one or more groups identified in the respective subset of direct group membership information for the first set of principals.

In some examples of the method, apparatus, and non-transitory computer-readable medium described herein, performing the graph traversal procedure may include operations, features, means, or instructions for performing, after performing the iteration, one or more second iterations of the set of multiple iterations until respective direct group membership information for all of the set of multiple principals may be identified and the set of multiple membership data structures for the set of multiple principals may be generated.

In some examples of the method, apparatus, and non-transitory computer-readable medium described herein, performing a union procedure of the one or more union procedures may include operations, features, means, or instructions for combining, in accordance with a logical OR operation, a first membership bitmap associated with a first principal from among the first set of principals with a second membership bitmap associated with a second principal from among the one or more groups, where combining the first membership bitmap and the second membership bitmap may be based on identifying that the first principal may be a direct member of the second principal within the hierarchical structure, and where the first membership bitmap indicates at least the first principal and the second membership bitmap indicates at least the second principal and one or more other principals that may be descendants from the second principal in the hierarchical structure and generating a first membership data structure for the second principal based on combining the second membership bitmap with the first membership bitmap and one or more other membership bitmaps associated with one or more other principals, from among the first set of principals, that may be direct members of the second principal within the hierarchical structure.

In some examples of the method, apparatus, and non-transitory computer-readable medium described herein, the first set of principals includes a set of multiple users within the IMS.

In some examples of the method, apparatus, and non-transitory computer-readable medium described herein, assigning a unique value of the set of multiple unique values may include operations, features, means, or instructions for identifying a unique ID of a principal from among the set of multiple principals identified from the snapshot and assigning a unique value to the principal based on identifying the unique ID for the principal, where the unique value includes an integer that corresponds to a position in a bitmap, and where the position may be representative of the principal.

In some examples of the method, apparatus, and non-transitory computer-readable medium described herein, a quantity of bits in the bitmap may be greater than or equal to a quantity of the set of multiple principals identified from the snapshot and a position of a bit in the quantity of bits corresponds to a respective unique value for a respective principal of the set of multiple principals.

In some examples of the method, apparatus, and non-transitory computer-readable medium described herein, the unique value may be based on an order in which the unique ID for the principal may be identified relative to other unique IDs being identified for other principals of the set of multiple principals identified from the snapshot.

In some examples of the method, apparatus, and non-transitory computer-readable medium described herein, generating a membership data structure of the set of multiple membership data structures may include operations, features, means, or instructions for generating, for a principal of the set of multiple principals, a membership bitmap that includes a quantity of bits, where one or more bits of the quantity of bits may be set to a first value and remaining bits of the quantity of bits may be set to a second value within the membership bitmap, the one or more bits set to the first value associated with one or more respective unique values of the set of multiple unique values that may be assigned to the principal and one or more other principals that descend from the principal in the hierarchical structure, where the quantity of bits in the membership bitmap may be equal to a quantity of principals of the set of multiple principals identified from the snapshot of the IMS.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary.” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
obtaining a snapshot of an identity management system that governs access to a set of computing objects for a plurality of principals, the plurality of principals comprising users and groups of users;
obtaining metadata for the plurality of principals based at least in part on information included in the snapshot, wherein the metadata for a principal comprises direct group membership information that indicates one or more groups of which the principal is a direct member;
assigning a plurality of unique values to the plurality of principals;
performing a graph traversal procedure for the plurality of principals, wherein performing the graph traversal procedure comprises identifying, based at least in part on the direct group membership information included in the metadata for the plurality of principals, a hierarchical structure comprising dependency chains between principals; and
generating, based at least in part on performing the graph traversal procedure, a plurality of membership data structures for the plurality of principals, wherein a membership data structure indicates one or more principals that descend from a corresponding principal based at least in part on a set of one or more unique values, from among the plurality of unique values, corresponding to the one or more descendant principals.

2. The method of claim 1, wherein the graph traversal procedure comprises a plurality of iterations, and wherein performing an iteration of the plurality of iterations comprises:
identifying, for a first set of principals from among the plurality of principals identified from the snapshot of the identity management system, a respective subset of metadata that corresponds to the first set of principals, wherein the respective subset of metadata comprises a respective subset of direct group membership information that indicates one or more groups of which principals in the first set of principals are direct members from within the hierarchical structure of the plurality of principals; and
performing, for the first set of principals and based at least in part on identifying the one or more groups, one or more union procedures to generate one or more membership data structures of the plurality of membership data structures, the one or more membership data structures for the one or more groups identified in the respective subset of direct group membership information for the first set of principals.

3. The method of claim 2, wherein performing the graph traversal procedure further comprises:
performing, after performing the iteration, one or more second iterations of the plurality of iterations until respective direct group membership information for all of the plurality of principals is identified and the plurality of membership data structures for the plurality of principals is generated.

4. The method of claim 2, wherein performing a union procedure of the one or more union procedures comprises:
combining, in accordance with a logical OR operation, a first membership bitmap associated with a first principal from among the first set of principals with a second membership bitmap associated with a second principal from among the one or more groups, wherein combining the first membership bitmap and the second membership bitmap is based at least in part on identifying that the first principal is a direct member of the second principal within the hierarchical structure, and wherein the first membership bitmap indicates at least the first principal and the second membership bitmap indicates at least the second principal and one or more other principals that are descendants from the second principal in the hierarchical structure; and
generating a first membership data structure for the second principal based at least in part on combining the second membership bitmap with the first membership bitmap and one or more other membership bitmaps associated with one or more other principals, from among the first set of principals, that are direct members of the second principal within the hierarchical structure.

5. The method of claim 2, wherein the first set of principals comprises a plurality of users within the identity management system.

6. The method of claim 1, wherein assigning a unique value of the plurality of unique values comprises:
identifying a unique identifier of a principal from among the plurality of principals identified from the snapshot; and
assigning a unique value to the principal based at least in part on identifying the unique identifier for the principal, wherein the unique value comprises an integer that corresponds to a position in a bitmap, and wherein the position is representative of the principal.

7. The method of claim 6, wherein:
a quantity of bits in the bitmap is greater than or equal to a quantity of the plurality of principals identified from the snapshot; and
a position of a bit in the quantity of bits corresponds to a respective unique value for a respective principal of the plurality of principals.

8. The method of claim 6, wherein the unique value is based at least in part on an order in which the unique identifier for the principal is identified relative to other unique identifiers being identified for other principals of the plurality of principals identified from the snapshot.

9. The method of claim 1, wherein generating a membership data structure of the plurality of membership data structures comprises:
generating, for a principal of the plurality of principals, a membership bitmap that comprises a quantity of bits, wherein one or more bits of the quantity of bits are set to a first value and remaining bits of the quantity of bits are set to a second value within the membership bitmap, the one or more bits set to the first value associated with one or more respective unique values of the plurality of unique values that are assigned to the principal and one or more other principals that descend from the principal in the hierarchical structure, wherein the quantity of bits in the membership bitmap is equal to a quantity of principals of the plurality of principals identified from the snapshot of the identity management system.

10. An apparatus, comprising:
one or more memories storing processor-executable code; and
one or more processors coupled with the one or more memories and individually or collectively operable to execute the code to cause the apparatus to:
obtain a snapshot of an identity management system that governs access to a set of computing objects for a plurality of principals, the plurality of principals comprising users and groups of users;
obtain metadata for the plurality of principals based at least in part on information included in the snapshot, wherein the metadata for a principal comprises direct group membership information that indicates one or more groups of which the principal is a direct member;
assign a plurality of unique values to the plurality of principals;
perform a graph traversal procedure for the plurality of principals, wherein performing the graph traversal procedure comprises identifying, based at least in part on the direct group membership information included in the metadata for the plurality of principals, a hierarchical structure comprising dependency chains between principals; and
generate, based at least in part on performing the graph traversal procedure, a plurality of membership data structures for the plurality of principals, wherein a membership data structure indicates one or more principals that descend from a corresponding principal based at least in part on a set of one or more unique values, from among the plurality of unique values, corresponding to the one or more descendant principals.

11. The apparatus of claim 10, wherein the graph traversal procedure comprises a plurality of iterations, and wherein, to perform an iteration of the plurality of iterations, the one or more processors are individually or collectively operable to execute the code to cause the apparatus to:
identify, for a first set of principals from among the plurality of principals identified from the snapshot of the identity management system, a respective subset of metadata that corresponds to the first set of principals, wherein the respective subset of metadata comprises a respective subset of direct group membership information that indicates one or more groups of which principals in the first set of principals are direct members from within the hierarchical structure of the plurality of principals; and
perform, for the first set of principals and based at least in part on identifying the one or more groups, one or more union procedures to generate one or more membership data structures of the plurality of membership data structures, the one or more membership data structures for the one or more groups identified in the respective subset of direct group membership information for the first set of principals.

12. The apparatus of claim 11, wherein, to perform the graph traversal procedure, the one or more processors are individually or collectively further operable to execute the code to cause the apparatus to:
perform, after performing the iteration, one or more second iterations of the plurality of iterations until respective direct group membership information for all of the plurality of principals is identified and the plurality of membership data structures for the plurality of principals is generated.

13. The apparatus of claim 11, wherein, to perform a union procedure of the one or more union procedures, the one or more processors are individually or collectively operable to execute the code to cause the apparatus to:
combine, in accordance with a logical OR operation, a first membership bitmap associated with a first principal from among the first set of principals with a second membership bitmap associated with a second principal from among the one or more groups, wherein combining the first membership bitmap and the second membership bitmap is based at least in part on identifying that the first principal is a direct member of the second principal within the hierarchical structure, and wherein the first membership bitmap indicates at least the first principal and the second membership bitmap indicates at least the second principal and one or more other principals that are descendants from the second principal in the hierarchical structure; and
generate a first membership data structure for the second principal based at least in part on combining the second membership bitmap with the first membership bitmap and one or more other membership bitmaps associated with one or more other principals, from among the first set of principals, that are direct members of the second principal within the hierarchical structure.

14. The apparatus of claim 11, wherein the first set of principals comprises a plurality of users within the identity management system.

15. The apparatus of claim 10, wherein, to assign a unique value of the plurality of unique values, the one or more processors are individually or collectively operable to execute the code to cause the apparatus to:
identify a unique identifier of a principal from among the plurality of principals identified from the snapshot; and
assign a unique value to the principal based at least in part on identifying the unique identifier for the principal, wherein the unique value comprises an integer that corresponds to a position in a bitmap, and wherein the position is representative of the principal.

16. A non-transitory computer-readable medium storing code, the code comprising instructions executable by one or more processors to:
obtain a snapshot of an identity management system that governs access to a set of computing objects for a plurality of principals, the plurality of principals comprising users and groups of users;
obtain metadata for the plurality of principals based at least in part on information included in the snapshot, wherein the metadata for a principal comprises direct group membership information that indicates one or more groups of which the principal is a direct member;
assign a plurality of unique values to the plurality of principals;
perform a graph traversal procedure for the plurality of principals, wherein performing the graph traversal procedure comprises identifying, based at least in part on the direct group membership information included in the metadata for the plurality of principals, a hierarchical structure comprising dependency chains between principals; and
generate, based at least in part on performing the graph traversal procedure, a plurality of membership data structures for the plurality of principals, wherein a membership data structure indicates one or more principals that descend from a corresponding principal based at least in part on a set of one or more unique values, from among the plurality of unique values, corresponding to the one or more descendant principals.

17. The non-transitory computer-readable medium of claim 16, wherein the graph traversal procedure comprises a plurality of iterations, and wherein, to perform an iteration of the plurality of iterations, the instructions are executable by the one or more processors to:
identify, for a first set of principals from among the plurality of principals identified from the snapshot of the identity management system, a respective subset of metadata that corresponds to the first set of principals, wherein the respective subset of metadata comprises a respective subset of direct group membership information that indicates one or more groups of which principals in the first set of principals are direct members from within the hierarchical structure of the plurality of principals; and
perform, for the first set of principals and based at least in part on identifying the one or more groups, one or more union procedures to generate one or more membership data structures of the plurality of membership data structures, the one or more membership data structures for the one or more groups identified in the respective subset of direct group membership information for the first set of principals.

18. The non-transitory computer-readable medium of claim 17, wherein, to perform the graph traversal procedure, the instructions are further executable by the one or more processors to:
perform, after performing the iteration, one or more second iterations of the plurality of iterations until respective direct group membership information for all of the plurality of principals is identified and the plurality of membership data structures for the plurality of principals is generated.

19. The non-transitory computer-readable medium of claim 17, wherein, to perform a union procedure of the one or more union procedures, the instructions are executable by the one or more processors to:
combine, in accordance with a logical OR operation, a first membership bitmap associated with a first principal from among the first set of principals with a second membership bitmap associated with a second principal from among the one or more groups, wherein combining the first membership bitmap and the second membership bitmap is based at least in part on identifying that the first principal is a direct member of the second principal within the hierarchical structure, and wherein the first membership bitmap indicates at least the first principal and the second membership bitmap indicates at least the second principal and one or more other principals that are descendants from the second principal in the hierarchical structure; and
generate a first membership data structure for the second principal based at least in part on combining the second membership bitmap with the first membership bitmap and one or more other membership bitmaps associated with one or more other principals, from among the first set of principals, that are direct members of the second principal within the hierarchical structure.

20. The non-transitory computer-readable medium of claim 17, wherein the first set of principals comprises a plurality of users within the identity management system.
